(19) United States
(12) Patent Application Publication
(10) Pub. No.: US 2023/0110970 A1
(43) Pub. Date: Apr. 13, 2023

(54) MULTIPLE SAMPLE ANALYSIS METHOD

(71) Applicant: SHIMADZU CORPORATION, Kyoto (JP)

(72) Inventors: Akira NISHIO, Kyoto (JP); Yuichiro FUJITA, Kyoto (JP)

(21) Appl. No.: 17/894,611

(22) Filed: Aug. 24, 2022

(30) Foreign Application Priority Data
Oct. 7, 2021 (JP) 2021-165425

(51) Int. Cl. G01N 30/86

(52) U.S. Cl. CPC G01N 30/8631; G01N 30/8675

(57) ABSTRACT

A first analysis step of acquiring a three-dimensional chromatogram of at least one sample by executing, for the sample, first chromatography analysis using a photodiode array under a condition that a plurality of components contained in the sample can be separated from each other, and extracting spectrum data of each of a plurality of the components contained in the sample from the three-dimensional chromatogram of the sample, a second analysis step of executing second chromatography analysis using a photodiode array on another sample whose main component is the same as that of the sample under a condition that a three-dimensional chromatogram can be obtained in a shorter time than the first chromatography analysis to acquire a three-dimensional chromatogram of the another sample, and a peak separation step of acquiring peak separated data for the another sample in which peaks of a plurality of components contained in the another sample are separated from each other are included by applying peak separation processing based on the spectrum data extracted in the first analysis step to the three-dimensional chromatogram of the another sample acquired in the second analysis step.

### BACKGROUND OF THE INVENTION

### 1. Field of the Invention

The present invention relates to a multiple sample analysis method for acquiring chromatogram data in a state where peaks of contained components are separated from each other for a plurality of samples having a common main component.

### 2. Description of the Related Art

In the pharmaceutical industry and the like, the concentration of impurities contained in each of a large number of samples having a common main component may need to be quantified. Liquid chromatography analysis is generally used as a method for quantifying each of a plurality of components contained in a sample (see WO 2018/027880 A).

### SUMMARY OF THE INVENTION

In order to quantify each of a plurality of components contained in a sample using liquid chromatography analysis, peaks of a plurality of components need to be separated from each other. In a case where a plurality of components having similar properties are mixed in a sample, in order to completely separate component peaks of the components, it is necessary to adjust an analytical condition in such a manner as adjusting a filler provided in an analysis column, increasing the total length of an analysis column, or narrowing an inner diameter of an analysis column to extremely reduce a flow rate of a mobile phase. As a result of performing analysis under such an analysis condition, the time required for all the components in a sample to be eluted from an analysis column becomes long, and it takes a long time to complete analysis of one sample. However, when the number of samples to be analyzed is enormous, it is not realistic to perform such a long time analysis on all of the samples because the cost, time, and human cost become enormous.

The present invention has been made in view of the above problem, and an object of the present invention is to provide a multiple sample analysis method capable of efficiently analyzing a plurality of samples having a common main component.

A multiple sample analysis method according to the present invention includes a first analysis step of acquiring a three-dimensional chromatogram of at least one sample by executing, for the sample, first chromatography analysis using a photodiode array under a condition that a plurality of components contained in the sample can be separated from each other, and extracting spectrum data of each of a plurality of the components contained in the sample from the three-dimensional chromatogram of the sample, a second analysis step of executing second chromatography analysis using a photodiode array on another sample whose main component is the same as that of the sample under a condition that a three-dimensional chromatogram can be obtained in a shorter time than the first chromatography analysis to acquire a three-dimensional chromatogram of the another sample, and a peak separation step of acquiring peak separated data for the another sample in which peaks of a plurality of components contained in the another sample are separated from each other by applying peak separation processing based on the spectrum data extracted in the first analysis step to the three-dimensional chromatogram of the another sample acquired in the second analysis step.

That is, in the present invention, the long-time first chromatography analysis by which high separation degree can be obtained is performed for some samples among a plurality of samples having a common main component, and spectrum data for a plurality of components is acquired. The second chromatography analysis by which a three-dimensional chromatogram can be obtained at a high speed with separation degree lower than that of the first chromatography analysis is performed for the other remaining samples, and peak separation processing based on the spectrum data obtained by performing the first chromatography analysis is applied to the three-dimensional chromatogram with a relatively low separation degree obtained by the second chromatography analysis, so that peak separated data for the other remaining samples is acquired.

As described above, according to the multiple sample analysis method of the present invention, the long-time first chromatography analysis by which high separation degree can be obtained is performed only for some samples among a plurality of samples having a common main component, and the second chromatography analysis by which a three-dimensional chromatogram can be obtained at a high speed is performed for the other samples although the separation degree is lower than that of the first chromatography analysis. This makes it possible to acquire highly accurate peak separated data for all samples without performing the first chromatography analysis that takes a long time for all of a plurality of samples having a common main component. Therefore, analysis of a plurality of samples having a common main component can be efficiently executed.

### BRIEF DESCRIPTION OF THE DRAWINGS

FIG. 1 is a schematic configuration diagram illustrating a configuration example of a liquid chromatography analysis device;

FIG. 2 is a conceptual diagram schematically illustrating an embodiment of a multiple sample analysis method; and

FIG. 3 is a flowchart illustrating an example of a process of the embodiment.

### DETAILED DESCRIPTION OF THE INVENTION

Hereinafter, an embodiment of a multiple sample analysis method according to the present invention will be described with reference to the accompanying drawings.

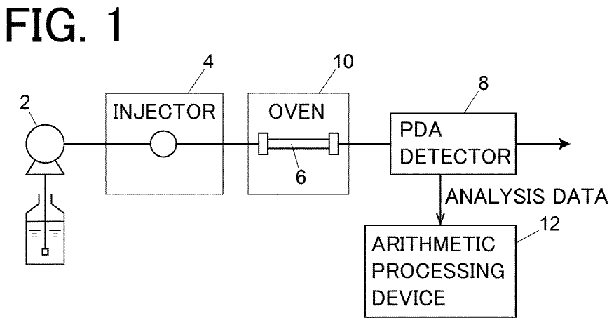

First, a configuration example of a liquid chromatography analysis device used for carrying out the multiple sample analysis method will be described with reference to FIG. 1.

The liquid chromatography analysis device includes a liquid delivery pump 2, an injector 4, an analysis column 6, a PDA detector 8, an oven 10, and an arithmetic processing device 12. The liquid delivery pump 2 feeds a mobile phase. The injector 4, the analysis column 6, and the PDA detector 8 are connected to the downstream side of the liquid delivery pump 2 in this order from the upstream side. The injector 4 is for injecting a sample into a mobile phase fed by the liquid delivery pump 2. The analysis column 6 is for separating components in the sample injected into a mobile phase by the injector 4 from each other. The analysis column 6 is housed inside the oven 10 and is controlled to a temperature corresponding to an analysis condition. The PDA detector 8 measures a temporal change in absorbance of eluate from the analysis column 6 for each wavelength band. That is, the PDA detector 8 acquires analysis data including chromatogram information representing a temporal change in absorbance in each measurement wavelength band and spectrum information representing a spectrum at each time during analysis.

The arithmetic processing device 12 is realized by a computer device including a central processing unit (CPU), a data storage device, and the like. Analysis data output from the PDA detector 8 is input to the arithmetic processing device 12. The arithmetic processing device 12 has a function of executing various pieces of analysis processing using the analysis data output from the PDA detector 8. As the analysis processing function by the arithmetic processing device 12, there are a function of creating a three-dimensional chromatogram having both chromatogram information and spectrum information for a sample, a function of extracting spectrum data of each of components separated from each other in the analysis column 6 based on the created three-dimensional chromatogram, and a function of executing peak separation processing for the three-dimensional chromatogram using the extracted spectrum data. That is, the arithmetic processing device 12 has a function of accumulating spectrum data extracted from a three-dimensional chromatogram in a database by performing analysis processing once, and using the spectrum data accumulated in the database for peak separation processing for another three-dimensional chromatogram.

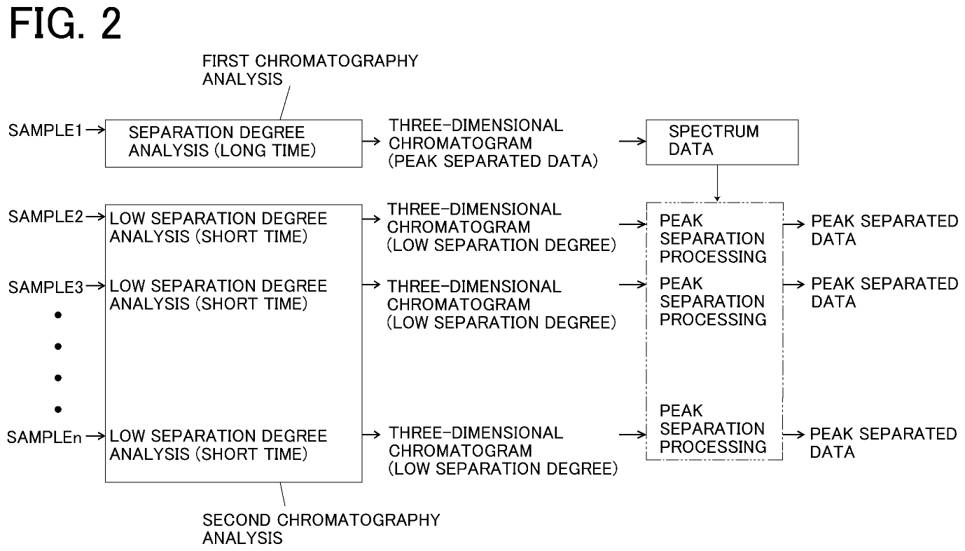

Next, a concept of the multiple sample analysis method will be described with reference to FIG. 2.

There are assumed to be a plurality of samples 1 to n to be analyzed. These samples 1 to n have a common main component. The analysis is performed by a liquid chromatography device having the configuration shown in FIG. 1 for the purpose of quantifying the concentration of each of a plurality of components contained in the samples 1 to n.

For the sample 1, a high separation degree condition that a high peak separation degree between a main component peak and a peak of a nearby component is obtained is searched for, and analysis is performed under the high separation degree condition (first chromatography analysis). An analysis condition includes elements such as an inner diameter and a length of the analysis column 6, a type of filler in the analysis column 6, a set temperature of the oven 10, composition of a mobile phase fed by the liquid delivery pump 2, a liquid feeding flow rate by the liquid delivery pump 2, and an injection condition by the injector 4. The elements are determined such that at least a peak of a main component of the sample 1 and a peak of another component appearing near the main component are isolated, preferably all components contained in the sample 1 are isolated.

By the first chromatography analysis described above, a three-dimensional chromatogram in which peaks of a plurality of components contained in the sample 1 are separated from each other is obtained, and spectrum data of each of components isolated in the first chromatography analysis is obtained from the three-dimensional chromatogram.

Here, in general, analysis under a condition optimized to completely separate peaks of a plurality of components in a sample as in the first chromatography analysis requires a relatively long time to elute all components from the analysis column 6. For this reason, when such high separation degree analysis is performed for all of a plurality of the samples 1 to n, it takes an enormous time to obtain analysis results for all of the samples 1 to n.

In view of the above, for each of the samples 2 to n other than the sample 1, analysis is performed under a condition that all components are eluted from the analysis column 6 in a shorter time than the first chromatography analysis (second chromatography analysis). In the second chromatography analysis, an analysis column different from that in the first chromatography analysis can be used. That is, a first analysis column used in the first chromatography analysis and a second analysis column used in the second chromatography analysis may be different from each other in an inner diameter, a length, and/or a type of the filler.

In a three-dimensional chromatogram obtained by the second chromatography analysis, an interval between peaks is shorter and the separation degree is lower than that in the first chromatography analysis, and peaks of a plurality of components may overlap each other. In that case, each piece of analysis data obtained by the second chromatography analysis is incomplete that cannot be used as it is for quantification of a component contained in the samples 2 to n.

In order to eliminate the incompleteness of analysis data obtained by the second chromatography analysis, peak separation processing is applied to each piece of analysis data. The peak separation processing is processing of estimating the shape and size of each of peaks of a plurality of components overlapping each other on a chromatogram. In the peak separation processing, in addition to an algorithm (see, for example, WO 2016/035167) for estimating a chromatogram of each component by applying a model function (peak model) such as an exponential modified gaussian (EMG) function to a waveform of an actual chromatogram, an algorithm for mathematically estimating a chromatogram of each component by applying matrix decomposition such as non-negative matrix factorization (NMF) to original three-dimensional chromatogram data without using a model function, and a main component analysis algorithm such as principal component analysis (PCA) can be used.

In the above-described peak separation processing, even in a state where there is no information regarding a component contained in a sample, it is possible to estimate the number, shape, and size of peaks overlapping each other on three-dimensional chromatogram data. However, if there is spectrum data of at least one component among components of which peaks overlap each other, it is possible to improve estimation accuracy of the number, shape, and size of the peaks overlapping each other by using the spectrum data as basic information of the peak separation processing.

In the present embodiment, at least a part of spectrum data extracted from analysis data of the first chromatography analysis is used in the peak separation processing applied to each piece of analysis data acquired in the second chromatography analysis. Since the samples 1 to n have a common main component, spectrum data on the main component extracted from analysis data of the first chromatography analysis can be used for the peak separation processing. In this manner, the accuracy of an estimation result obtained by the peak separation processing on analysis data of the samples 2 to n can be improved. Note that in a case where all components contained in the samples 1 to n are the same, spectrum data of all the components isolated by the first chromatography analysis can be used for the peak separation processing, so that highly accurate peak separated data for the samples 2 to n can be acquired.

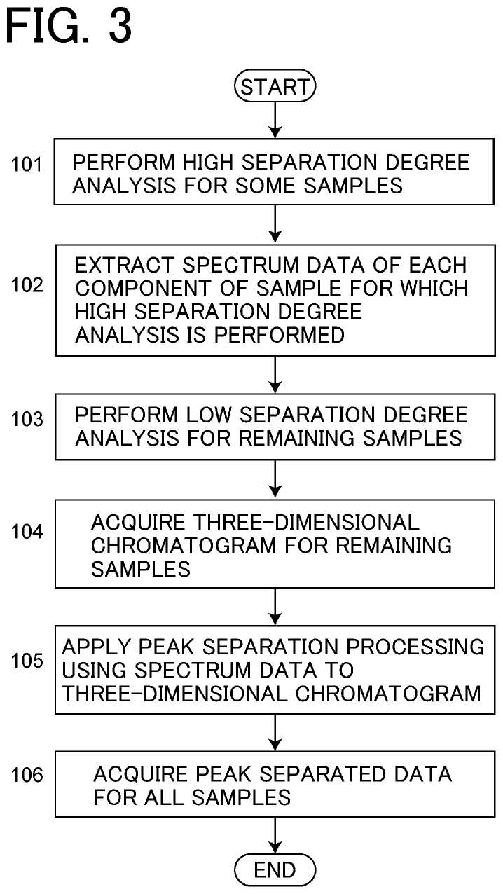

An example of a process of the multiple sample analysis method of the present embodiment will be described with reference to the flowchart of FIG. 3.

High separation degree analysis (first chromatography analysis) such that at least a main component peak and another component peak are completely separated is performed for some samples (only need to be one or more samples) among a large number of samples to be analyzed (Step 101). By analyzing analysis data obtained by the first chromatography analysis using the arithmetic processing device 12, spectrum data for each component isolated by the high separation degree analysis is extracted (Step 102). For some samples, the first chromatographic analysis provides peak separated data necessary for quantification of each component.

Next, for the remaining samples except for some samples for which the first chromatography analysis is performed, low separation degree analysis (second chromatography analysis) is performed such that analysis data can be acquired in a shorter time than the first chromatography analysis although the separation degree between peaks is lower than that of the first chromatography analysis (Step 103). In this manner, a three-dimensional chromatogram for the remaining samples is obtained (Step 104).

Peak separation processing based on the spectrum data extracted in Step 102 is applied to the three-dimensional chromatogram obtained by the second chromatography analysis (Step 105). By this peak separation processing, a plurality of peaks overlapping each other in the analysis data that is originally in an incomplete state are separated with high estimation accuracy, and peak separated data that can be used for quantification of each component contained in the sample is obtained. That is, by performing the peak separation processing in Step 105, it is possible to acquire an analysis result equivalent to that acquired in a case where the high separation degree analysis over a long period of time is performed on all the samples.

As described above, in the present embodiment, even in a case where there are an enormous number of samples to be analyzed, the first chromatography analysis is performed over a long period of time (and in some cases, at a high cost) under an analysis condition set so as to isolate a main component and another component only for at least one of the samples. However, the second chromatography analysis is performed only for the remaining samples in a short period of time (and in some cases, at a low cost). In this manner, it is possible to acquire an analysis result equivalent to that acquired in a case where the high separation degree analysis over a long period of time is performed for all the samples. Therefore, time required to acquire peak separated data for all the samples is greatly reduced.

The embodiment described above merely exemplifies an embodiment of the multiple sample analysis method according to the present invention. The embodiment of the multiple sample analysis method according to the present invention is as described below.

An embodiment of the multiple sample analysis method according to the present invention includes a first analysis step of acquiring a three-dimensional chromatogram of at least one sample by executing, for the sample, first chromatography analysis using a photodiode array under a condition that a plurality of components contained in the sample can be separated from each other, and extracting spectrum data of each of a plurality of the components contained in the sample from the three-dimensional chromatogram of the sample, a second analysis step of executing second chromatography analysis using a photodiode array on another sample whose main component is the same as that of the sample under a condition that a three-dimensional chromatogram can be obtained in a shorter time than the first chromatography analysis to acquire a three-dimensional chromatogram of the another sample, and a peak separation step of acquiring peak separated data for the another sample in which peaks of a plurality of components contained in the another sample are separated from each other by applying peak separation processing based on the spectrum data extracted in the first analysis step to the three-dimensional chromatogram of the another sample acquired in the second analysis step.

In a first aspect of the embodiment, a first analysis column used in the first chromatography analysis and a second analysis column used in the second chromatography analysis are different from each other in inner diameter, overall length, and/or filler. For example, in the first chromatography analysis, a relatively expensive analysis column can be used as the first analysis column to obtain a high peak separation degree, and in the second chromatography analysis, an analysis column less expensive than the first analysis column can be used. This can reduce the cost required to analyze all of a plurality of samples.

In a second aspect of the embodiment, a mobile phase flow rate in the second chromatography analysis is larger than a mobile phase flow rate in the first chromatography analysis. This second aspect can be combined with the first aspect.

In a third aspect of the embodiment, in a case where there are two or more samples having a common main component, the first analysis step is executed on one sample among the two or more samples to extract spectrum data of each of a plurality of components included in the one sample, and the second analysis step is executed on remaining samples among the two or more samples to acquire a three-dimensional chromatogram for each of the remaining samples, and the peak separation step is executed on the acquired three-dimensional chromatogram for each of the remaining samples to acquire peak separated data for each of the remaining samples. According to such an aspect, since the first chromatography analysis that takes a long time to analyze is performed only for one sample and the second chromatography analysis that is completed in a relatively short time is performed for the other remaining samples, the time required to complete analysis of all the samples can be greatly reduced. This third aspect can be combined with the first aspect and/or the second aspect described above.

In a fourth aspect of the embodiment, the first chromatography analysis and the second chromatography analysis are liquid chromatography analysis. The “chromatography analysis” in the present invention can include not only liquid chromatography analysis but also gas chromatography analysis. This fourth aspect can be combined with the first aspect, the second aspect, and/or the third aspect described above.

In a fifth aspect of the embodiment, in the peak separation processing, an algorithm for estimating a peak of each component by applying a model function or an algorithm for mathematically estimating a peak of each component by matrix decomposition without using the model function is used. This fifth aspect can be combined with the first aspect, the second aspect, the third aspect, and/or the fourth aspect described above.

### DESCRIPTION OF REFERENCE SIGNS

2 liquid delivery pump

4 injector

6 separation column

8 PDA detector

10 oven

12 arithmetic processing device

What is claimed is:

1. A multiple sample analysis method comprising:
a first analysis step of acquiring a three-dimensional chromatogram of at least one sample by executing, for the at least one sample, first chromatography analysis using a photodiode array under a condition that a plurality of components contained in the at least one sample can be separated from each other, and extracting spectrum data of each of the plurality of components contained in the at least one sample from the three-dimensional chromatogram of the at least one sample;
a second analysis step of executing second chromatography analysis using a photodiode array on another sample whose main component is the same as that of the at least one sample under a condition that a three-dimensional chromatogram can be obtained in a shorter time than the first chromatography analysis to acquire a three-dimensional chromatogram of the another sample; and
a peak separation step of acquiring peak separated data for the another sample in which peaks of a plurality of components contained in the another sample are separated from each other by applying peak separation processing based on the spectrum data extracted in the first analysis step to the three-dimensional chromatogram of the another sample acquired in the second analysis step.

2. The multiple sample analysis method according to claim 1, wherein a first analysis column used in the first chromatography analysis and a second analysis column used in the second chromatography analysis are different from each other in inner diameter, overall length, and/or filler.

3. The multiple sample analysis method according to claim 1, wherein a mobile phase flow rate in the second chromatography analysis is larger than a mobile phase flow rate in the first chromatography analysis.

4. The multiple sample analysis method according to claim 1, wherein
in a case where there are two or more samples having a common main component,
the first analysis step is executed on one sample among the two or more samples to extract spectrum data of each of a plurality of components included in the one sample, and
the second analysis step is executed on remaining samples among the two or more samples to acquire a three-dimensional chromatogram for each of the remaining samples, and the peak separation step is executed on the acquired three-dimensional chromatogram for each of the remaining samples to acquire peak separated data for each of the remaining samples.

5. The multiple sample analysis method according to claim 1, wherein the first chromatography analysis and the second chromatography analysis are liquid chromatography analysis.

6. The multiple sample analysis method according to claim 1, wherein in the peak separation processing, an algorithm for estimating a peak of each component by applying a model function or an algorithm for mathematically estimating a peak of each component by matrix decomposition without using the model function is used.
